(19) United States
(12) Patent Application Publication
(10) Pub. No.: US 2026/0346416 A1
(43) Pub. Date: Nov. 5, 2026

(54) ACTUATION MECHANISM

(71) Applicant: Illinois Tool Works Inc., Glenview, IL (US)

(72) Inventors: Tommaso Passerin d'Entreves et Courmayeur, Portes-lès-Valence (FR); Olivier Baudrand, Paris (FR)

(21) Appl. No.: 19/125,510

(22) PCT Filed: Nov. 16, 2023
(86) PCT No.: PCT/US2023/080074

§ 371 Date: Apr. 29, 2025

(30) Foreign Application Priority Data
Dec. 1, 2022 (FR) FR2212643

(51) Int. Cl. B25C 1/06; B25C 1/04; B25C 1/08

(52) U.S. Cl. CPC B25C 1/06; B25C 1/047; B25C 1/08

(57) ABSTRACT

An actuation mechanism for a nail driver, the mechanism comprising: an actuation mass; a propulsion mechanism on a first side of the actuation mass; a feed head on a second side of the actuation mass and separable the actuation mass; and an anvil on the feed head to drive a nail. When it is loaded, the propulsion means is configured to propel the actuation mass, thus launching the feed head to make the anvil drive a nail into a substrate.

### PRIORITY CLAIM

This application is a national stage application of PCT/US2023/080074, filed on Nov. 16, 2023, which claims priority to and the benefit of French Application No. 2212643, which was filed on Dec. 1, 2022, the entire contents of each of which is incorporated herein by reference.

### TECHNICAL FIELD

The present disclosure concerns in general an actuation mechanism. More specifically, although not exclusively, the present disclosure concerns an actuation mechanism for a nail driver.

### TECHNICAL BACKGROUND

It is known to provide a nail driver which incorporates an actuation mechanism to propel a mass bearing an anvil towards a nail (feed head), in order to drive the nail into a substrate.

However, in a conventional nail driver of this type, the actuation mechanism reduces the compactness of the tool.

### SUMMARY

The objective of the present disclosure is to provide an improved nail driver actuator. More specifically, the objective of the present disclosure is to provide an actuator which is more compact and/or more polyvalent than the known actuators.

The present disclosure concerns an actuation mechanism for a nail driver, the mechanism comprising an actuator and a feed head on which a nail driver anvil is fitted, wherein the mechanism can be used to make the actuator apply a propulsion force on the feed head, and the feed head is configured to be separated from the actuator after having received the propulsion force.

This separation allows the actuator to be more compact, thus providing a high level of propulsion force over a short distance, while allowing the impetus of a relatively heavy feed head to force the anvil against a nail to be driven into a substrate.

The actuator can comprise an actuation mass. The actuator can comprise a propulsion mechanism, which can be on a first side of the actuation mass. The feed head can be on a second side of the actuation mass. The feed head can be separable from the actuation mass.

When it is loaded, the propulsion mechanism can be configured to propel the actuation mass, for example thus launching the feed head from or by way of the actuation mass, in order to make the anvil drive a nail into a substrate.

The present disclosure also concerns an actuation mechanism for a nail driver, the mechanism comprising: an actuation mass; a propulsion mechanism on a first side of the actuation mass; a feed head which is on a second side of the actuation mass, and is separable therefrom; and an anvil fitted on the feed head in order to engage a nail, wherein, when it is loaded, the propulsion mechanism is configured to propel the actuation mass, thus launching the feed head by way of the actuation mass in order to make the anvil drive a nail into a substrate.

The actuation mechanism can comprise a first stop or a first limit stop, for example in order to limit the displacement of the actuation mass to a first distance. The actuation mechanism can comprise a second stop or a second limit stop, for example in order to limit the displacement of the feed head to a second distance. The second distance can be longer than the first distance.

More specifically, the actuation mechanism can comprise a first limit stop in order to limit the displacement of the actuation mass to a first distance, and a second stop in order to limit the displacement of the feed head to a second distance, which is longer than the first distance.

By stopping the actuation mass before the anvil comes into contact with the nail (and slightly after the loading of the propulsion mechanism), the recoil which a user undergoes can be reduced.

The feed head can be heavier than the actuation mass. The mass of the feed head can be at least twice that of the actuation mass. The mass of the feed head can be at least three times that of the actuation mass. The mass of the feed head can be at least four times, for example five times, that of the actuation mass.

The minimization of the weight of the actuation mass compared with that of the feed head can reduce the loss of kinetic energy, in particular when the actuation mass comes into contact with the first stop.

The actuation mechanism can comprise an elastic or resilient mechanism. The elastic or resilient mechanism can be between the feed head and the actuation mass.

More specifically, the actuation mechanism can comprise an elastic or resilient mechanism between the feed head and the actuation mass.

The inclusion of an elastic or resilient mechanism between the feed head and the actuation mass transmits a larger part of the kinetic energy from the actuation mechanism to the feed head, thus reducing the losses further.

The actuation mass can comprise a plate. The plate can for example have the form of a disc or a ring. The plate can comprise a plate made of material which conducts electricity, such as, for example, copper and its different alloys, or also aluminum, gold, or silver. The plate can comprise a metal plate.

The propulsion mechanism can comprise a coil. The coil can comprise an electrical coil. The coil can propel the actuation mass, for example the plate.

More specifically, the actuation mass can comprise a metal plate, and the propulsion mechanism can comprise an electrical coil in order to propel the metal plate.

The metal plate can comprise a metal disc.

The propulsion mechanism can comprise a first coil, for example a first electrical coil. The actuation mass can comprise a second coil, for example a second electrical coil. The first and second coils can be configured to operate together, for example in order to propel the second electrical coil, in order to launch the feed head so as to make the anvil drive a nail into a substrate.

More specifically, the propulsion mechanism can comprise a first electrical coil, and the actuation mass comprises a second electrical coil, and the first and second electrical coils can operate together in order to propel the second electrical coil, in order to launch the feed head so as to make the anvil drive a nail into a substrate.

The propulsion mechanism can comprise a pneumatic source or a source of combustion in order to propel the actuation mass.

The actuation mechanism can comprise a first housing. The first housing can receive at least partly the actuation mass and/or the propulsion mechanism. The actuation mechanism can comprise a second housing. The second housing can receive at least partly the feed head. The first and second housings can be separable. The first and second housings can comprise characteristics or fitting elements which cooperate, for example in order to fit the second housing on the first housing in a removable manner.

More specifically, the actuation mechanism can comprise a first housing which receives at least partly the actuation mass and the propulsion mechanism, and a second housing which receives at least partly the feed head, wherein the first and second housings are separable and comprise fitting characteristics which cooperate, in order to fit the second housing on the first housing in a removable manner.

The actuation mechanism can comprise a guide, for example in order to guide the movement of the feed head. The guide can guide the movement of the feed head between the retracted and firing positions. The guide can receive the feed head. The guide can be tubular. The guide can comprise a first guide. The actuation mechanism can comprise a second guide, for example in order to guide the movement of the actuation mass. The second guide can guide the movement of the actuation mass between the retracted and deployed or actuated positions. The second guide can receive the actuation mass. The second guide can be tubular.

The present disclosure also concerns an actuator, which can be configured to be used in the actuation mechanism described above, the actuator comprising a housing which receives at least partly an actuation mass and a propulsion mechanism on a first side of the actuation mass, and wherein the housing comprises an opening in a second side of the actuation mass, in order to allow the actuation mass to cooperate with a feed head of a launcher, and a fitting characteristic, in order to allow the actuator to be fitted in a removable manner on a launcher.

The actuator can comprise a stop or a limit stop. The stop or the limit stop can be to limit the displacement of the actuation mass.

More specifically, the actuator can comprise a limit stop in order to limit the displacement of the actuation mass.

The actuator can comprise an elastic or resilient mechanism. The elastic or resilient mechanism can be fitted on the second side of the actuation mass, for example in order to cooperate in use with a feed head of a launcher on which the actuator is fitted.

More specifically, the actuator can comprise an elastic mechanism which is fitted on the second side of the actuation mass, in order to cooperate in use with a feed head of a launcher on which the actuator is fitted.

The actuator can comprise a guide, for example in order to guide the movement of the actuation mass. The guide can guide the movement of the actuation mass between the retracted and deployed or actuated positions. The guide can receive the actuation mass. The second guide can be tubular.

The mechanism for propulsion of the actuation mechanism or of the actuator can comprise an electrical or electromechanical propulsion mechanism, or an actuator, or an electrical coil, or an actuator, or an electromechanical coil. The mechanism for propulsion of the actuation mechanism or of the actuator can comprise a pneumatic propulsion mechanism, or a chamber, or a pneumatic actuator. The mechanism for propulsion of the actuation mechanism or the actuator can comprise a mechanism for combustion, or a combustion chamber, or an actuator.

The present disclosure also concerns a launcher, which can be configured to be used in the actuation mechanism described above, the launcher comprising a housing which receives at least partly a feed head, and an anvil fitted on the feed head in order to drive a nail, wherein the housing comprises an opening, in order to allow the feed head to cooperate with an actuation mass of an actuator, and a fitting characteristic, in order to allow the launcher to be fitted in a removable manner on an actuator.

The launcher can comprise a stop or a limit stop. The stop or the limit stop can make it possible to limit the displacement of the feed head.

More specifically, the launcher can comprise a limit stop in order to limit the displacement of the feed head.

The launcher can comprise an elastic or resilient mechanism. The elastic or resilient mechanism can be fitted on the feed head on a side which faces the opening in the housing of the launcher, for example in order to cooperate in use with an actuation mass of an actuator on which the launcher is fitted.

More specifically, the launcher can comprise an elastic mechanism fitted on the feed head on a side which faces the opening in the housing of the launcher, in order to cooperate in use with an actuation mass of an actuator on which the launcher is fitted.

The launcher can comprise a guide, for example in order to guide the movement of the feed head. The guide can guide the movement of the feed head between the retracted and firing positions. The guide can receive the feed head. The guide can be tubular.

The elastic or resilient mechanism of the actuation mechanism or of the actuator or of the launcher can comprise an elastic or resilient element or member. The elastic or resilient mechanism of the actuation mechanism or of the actuator or of the launcher can comprise a tubular elastic or resilient element or member. The elastic or resilient mechanism of the actuation mechanism or of the actuator or of the launcher can comprise a spring, such as a helical spring, a compression spring, or a tension spring.

The stop or each stop or the limit stop or each limit stop can comprise a damper.

The present disclosure also concerns a nail driver comprising an actuation mechanism described above.

In order to avoid any doubt, all the characteristics described here also apply to all aspects of the present disclosure.

Within the context of the present disclosure, it is specifically intended that the various aspects, embodiments, examples and alternatives described in the preceding paragraphs, in the claims, and/or in the description and the following drawings, and in particular the individual characteristics thereof, can be taken independently or in any combination. In other words, all the embodiments and/or the characteristics of any embodiment can be combined in any way, unless these characteristics are incompatible.

In order to avoid any ambiguity, the terms “can”, “and/or”, “for example”, and any other similar term used in the present document, must be interpreted as being non-limiting, such that every characteristic thus described need not necessarily be present. In fact, any combination of optional characteristics is specifically envisaged, without departing from the scope of the present disclosure, whether these characteristics are specifically claimed or not. The applicant reserves the right to modify any claim originally filed, or to file any new claim accordingly, including the right to modify any claim originally filed in order for it to depend on and/or incorporate any characteristic of any other claim, although it is not originally claimed in this manner.

### BRIEF DESCRIPTION OF THE FIGURES

Other characteristics and advantages of the present disclosure will become apparent from reading the following detailed description, for understanding of which reference will be made to the appended drawings, in which:

FIG. 1 is a schematic view of a nail driver comprising an actuation mechanism according to the present disclosure;

FIG. 2 illustrates the actuation mechanism according to an embodiment of the present disclosure, in the case of a propulsion mechanism of the electromagnetic type with a single coil;

FIG. 3 illustrates the actuation mechanism according to an embodiment of the present disclosure, in the case of a propulsion mechanism of the electromagnetic type with a single coil;

FIG. 4 illustrates the actuation mechanism according to an embodiment of the present disclosure, in the case of a propulsion mechanism of the electromagnetic type with a single coil;

FIG. 5 illustrates a variant of the actuation mechanism of FIGS. 2 to 4, in the case of use of nails with long lengths;

FIG. 6 illustrates a variant of the actuation mechanism of FIGS. 2 to 4, in the case of use of nails with long lengths;

FIG. 7 illustrates a variant of the actuation mechanism of FIGS. 2 to 4, in the case of use of nails with long lengths;

FIG. 8 illustrates a variant of the actuation mechanism, with use of an elastic element making it possible to optimize the performance;

FIG. 9 illustrates a variant of the actuation mechanism, with use of elastic element making it possible to optimize the performance;

FIG. 10 illustrates the actuation mechanism comprising two removable housings;

FIG. 11 illustrates the two housings of FIG. 10;

FIG. 12 illustrates the two housings of FIG. 10;

FIG. 13 illustrates the two housings of FIG. 10;

FIG. 14 illustrates a variant of the actuation mechanism, in the case of a propulsion mechanism of the electromagnetic type with two coils;

FIG. 15 illustrates the actuation mechanism comprising a pneumatic source in order to propel an actuation mass; and

FIG. 16 illustrates the actuation mechanism comprising a source of combustion in order to propel an actuation mass.

### DETAILED DESCRIPTION

While the systems, devices, and methods described herein may be embodied in various forms, the drawings show, and the specification describes certain exemplary and non-limiting embodiments. Not all components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, connected, etc., are not intended to be limited to direct mounting methods but should be interpreted broadly to include indirect and operably mounted, connected, and like mounting methods. This specification is intended to be taken as a whole and interpreted in accordance with the principles of the present disclosure and as understood by one of ordinary skill in the art.

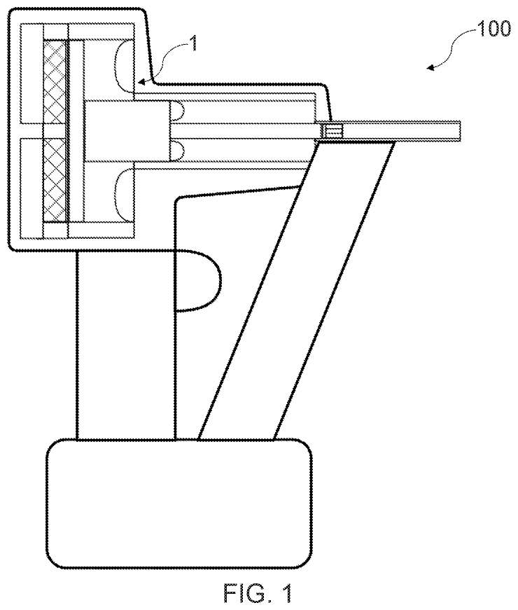

With reference now to FIG. 1, a nail driver 100 can be seen comprising an actuation mechanism 1 according to an embodiment of the present disclosure.

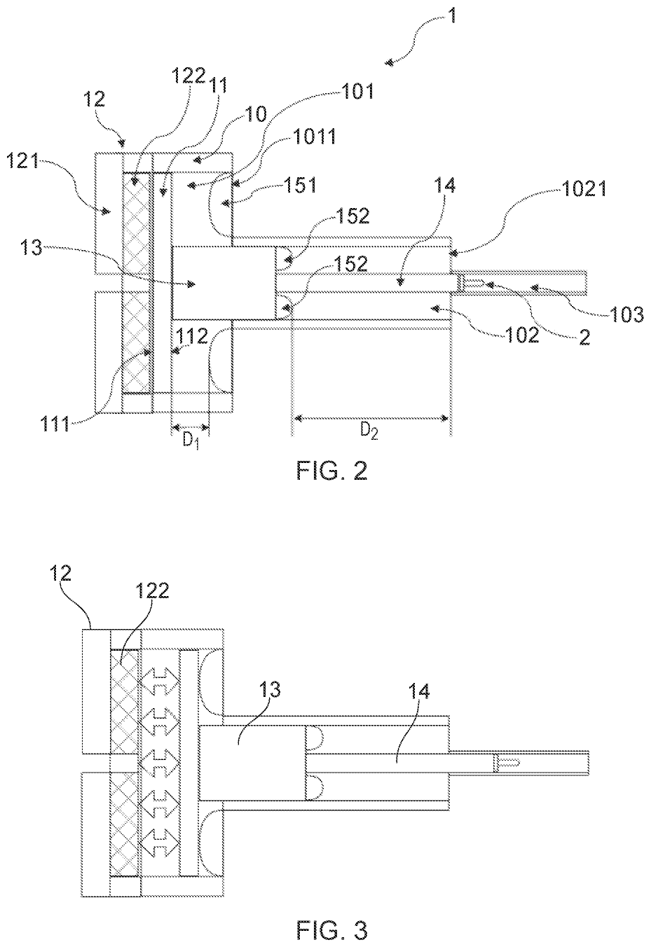

The actuation mechanism 1 is described in greater detail in relation with FIGS. 2 to 4, according to an embodiment.

The actuation mechanism 1 is composed of a frame 10 comprising a first receptacle 101, a second receptacle 102, and a third receptacle 103. It also comprises an actuation mass 11 which is propelled by a propulsion mechanism 12.

This propulsion mechanism 12 is positioned on a first side 111 of the actuation mass 11. In the example of FIG. 2, the propulsion mechanism 12 is composed of a coil 122 and a stator 121. This propulsion mechanism 12 can differ in its structure, as described later in the description.

Also, a feed head 13 is positioned on a second side 112 of the actuation mass 11, and is separable therefrom.

An anvil 14 is fitted on this feed head 13 in order to drive a nail 2 once the feed head 13 has been propelled by the actuation mass 11.

The actuation mass 11 is configured to be displaced in the first receptacle 101, the feed head is configured to be displaced in the second receptacle 102, and the anvil 14 is designed to be displaced in the third receptacle 103.

According to the present disclosure, when it is loaded, the propulsion mechanism 12 is configured to propel the actuation mass 11, thus launching the feed head 13 from or by way of the actuation mass 11, in order to make the anvil 14 drive the nail 2 into a substrate (not represented).

The frame 10 also comprises a first limit stop 1011 to limit the displacement of the actuation mass 11 to a first distance D₁ and a second limit stop 1021 in order to limit the displacement of the feed head 13 to a second distance D₂, which is longer than the first distance D₁.

The first and second limit stops 1011, 1021 are walls respectively of the first and second receptacles 101, 102 provided in the frame 10.

FIG. 3 illustrates the position of the actuation mass 11, once it has been displaced by the propulsion mechanism 12. Before actuation of the propulsion mechanism 12, the actuation mass 11 is in contact with the feed head 13. Once the propulsion mechanism 12 has been actuated, the actuation mass 11 and the feed head 13, which is in non-integral contact therewith, are displaced over a distance D1 in the first receptacle 101 provided in the frame 10. Then, the actuation mass 11 abuts the first limit stop 1011, and releases the feed head 13 by the effect of transfer of energy between the actuation mass 11 and the feed head 13.

In order to limit the level of intensity of the impacts between the actuation mass 11 and the first limit stop 1011, a first energy absorber 151 is provided on the first limit stop 1011, or on the second side 112 of the actuation mass 11, thus making it possible to damp the collision between the actuation mass 11 and the frame 10 of the actuation mechanism 1. For example, the first energy absorber 151 is made of a compressible material of the foam or plastic type with low Shore hardness. This makes it possible to avoid impacts with the frame, and to increase the service life of the device.

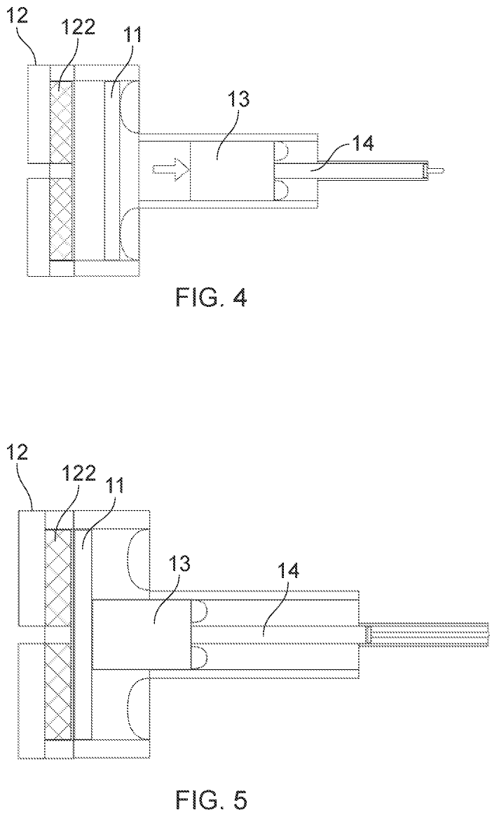

FIG. 4 illustrates the position of the feed head 13 once it has been displaced by the actuation mass 11. The feed head 13 is then displaced over a distance D₂ in the second receptacle 102 of the frame 10. Then, once the feed head 13 is abutting the wall 1021 of the second receptacle, a second energy absorber 152, which in this case is provided on the feed head, is compressed under the effect of the pressure of the feed head against the second limit stop 1021, and releases the nail 2, the nail 2 being in non-integral contact with the anvil 14. According to a variant, the second energy absorber 152 can also be provided on the second limit stop 1021.

The nail 2 is advantageously guided in the third receptacle 103, which is configured to guide the nail over a greater or lesser distance according to the application required. This guide 103 can be removable, by being secured, for example by screwing, on the second receptacle 102.

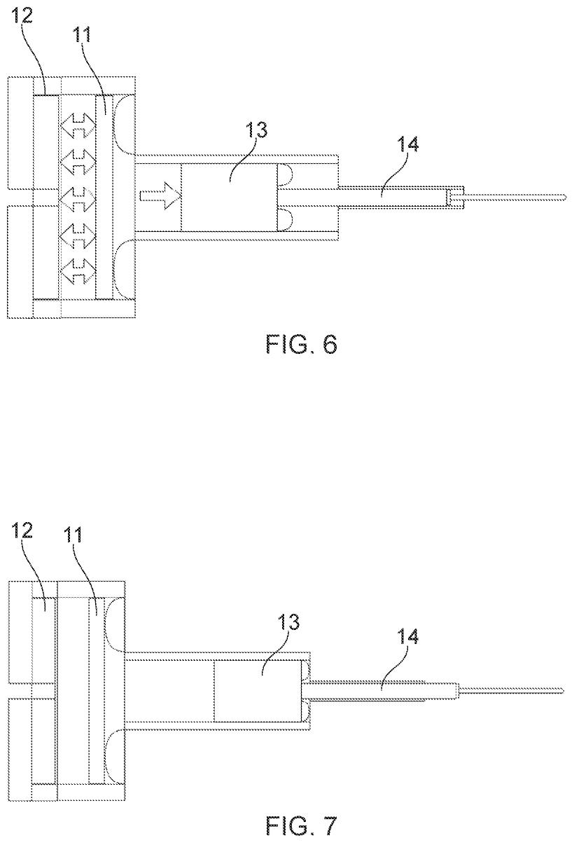

According to a variant illustrated in FIGS. 5 to 7, the nail 2 has dimensions equal to the third receptacle 103. Thus, nails with large sizes can be nailed by the nail driver 100 using the actuation mechanism 1 according to the present disclosure.

According to a characteristic of the present disclosure, the feed head 13 is heavier than the actuation mass 11.

According to the basic principle, the kinetic energy of the actuation mass 11 is transmitted to the body of the tool, and is therefore not used to drive in the nail 2.

Although part of this energy can be used to compensate for the recoil of the tool, thus limiting the loss of performance, part of it will be lost.

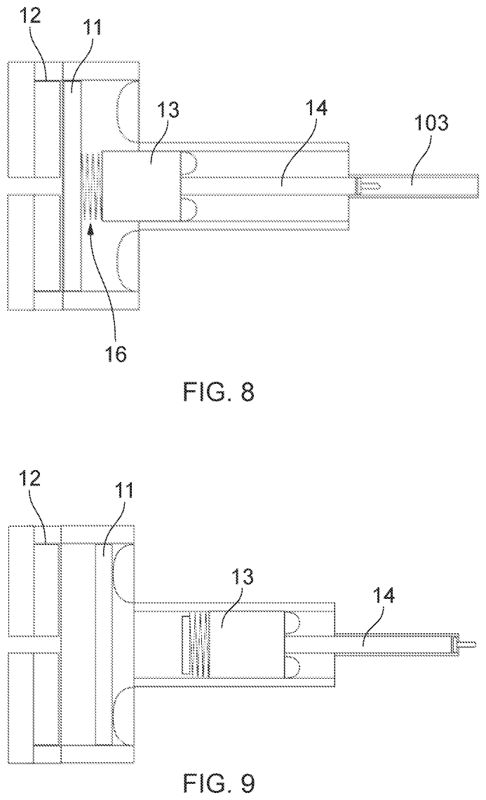

In order to limit these losses, possible optimization consists of the addition of an elastic mechanism 16 (for example a spring) in series between the actuation mass 11 and the feed head 13, as illustrated in FIGS. 8 and 9.

In this concept, the elastic mechanism 16 accumulates part of the energy transmitted by the actuation mass 11. This energy is restored to the feed head 13 at the moment of stoppage of the actuation mass 11. Any energy which has accumulated in the elastic mechanism 16 is not lost during the damping of the actuation mass 11, thus improving the global performance. Consequently, a variant of this type makes it possible to optimize the performance during the nailing operation.

According to another variant, the actuation mass 11 comprises an electrically conductive plate, for example a metal plate (not represented, for example made of copper), and the propulsion mechanism 12 comprises an electrical coil 122 in order to propel the metal plate.

The present disclosure thus operates according to the well-known Thompson's principle. In this case, an inductor (coil) 122 is positioned flat surrounded by a stator 121 which is made of ferromagnetic material, facing which there is actuation mass 11, for example a copper ring or disc. When a strong current is discharged into the coil 122, a repulsive force is created between the coil 122 and the copper ring. This force is transmitted by a piston (in this case the feed head 13 and anvil 14 assembly) until a nail 2 is driven in.

The particular feature of the present disclosure provides that the copper part (or more generally the plate) which reacts with the coil 122 is not incorporated in the piston (in this case the feed head 13 and anvil 14 assembly) which drives the nail 2, but that it is an intermediate actuator (in this case the actuation mass 11) which covers only a reduced course D₁ relative to the piston which drives the nail.

“Actuator” thus designates the sub-assembly which generates the mechanical force, and “launcher” designates the sub-assembly which is designed to drive in the nail.

According to this principle, the piston is displaced as a single assembly over the first part of the course (D₁). Once the area of interaction between the coil 122 and the plate (in this example the copper part) has been passed, the actuation mass 11 comprising the plate (copper ring) can be stopped, since it would not gain any more energy by continuing its movement.

The feed head 13 (the mass of which is substantially greater than that of the actuation mass 11) is then separated from the actuation mass 11, and its impetus continues along a second course D₂ (D₂>D₁) until a nail 2 is driven in, which can be substantially longer than the course of the actuator.

The principle is based on a ratio of masses, such that the masse M1 of the feed head 13 is very much greater than the masse M2 of the actuation mass 11, in order to minimize the energy losses which take place when the actuation mass is stopped (its kinetic energy is lost in the frame).

However, part of this energy transmitted by the masse M1 of the feed head 13 to the frame can be used to compensate for the recoil force which takes place in reaction to the displacement of the feed head forwards, thus limiting the loss of performance.

The major advantage of this architecture is that an actuator with a large diameter can be used to actuate a tool with a smaller mean diameter. This combines the power of an actuator with a large diameter with the accessibility permitted by a tool with a smaller diameter.

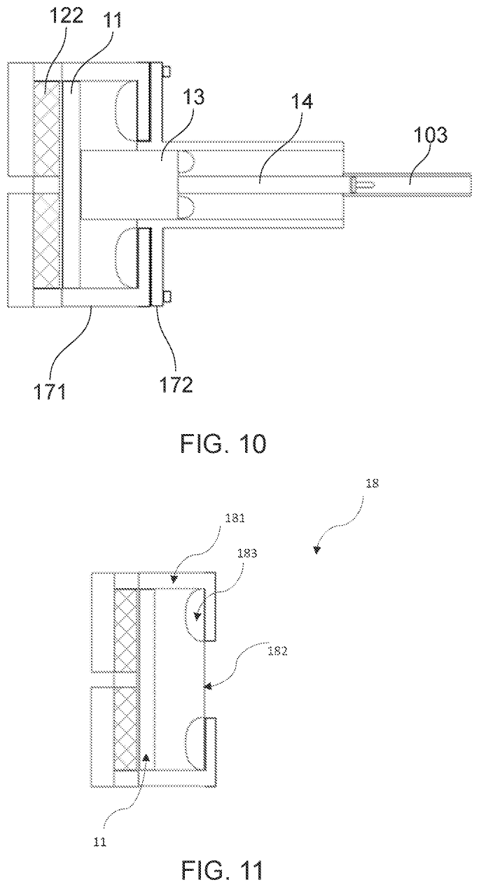

Another significant advantage is the modularity, which permits the separation of the actuator/launcher, as illustrated hereinafter in relation with FIGS. 10 to 14. Launchers with different diameters, courses, masses or cross-sections can be adapted to a single actuator, or to a single tool body comprising the actuator and its peripherals.

According to another variant in relation with FIG. 14, the propulsion mechanism 12 comprises a first electrical coil 122, and the actuation mass 11 comprises a second electrical coil 113, with the first and second electrical coils being able to operate together in order to propel the second electrical coil, so as to launch the feed head 13, in order to make the anvil drive a nail into a substrate.

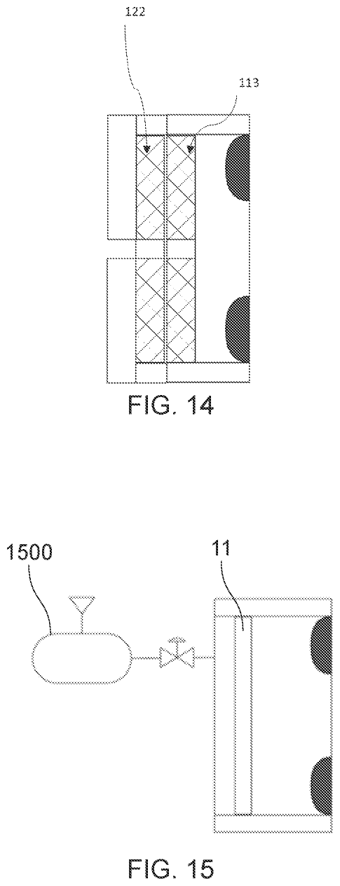

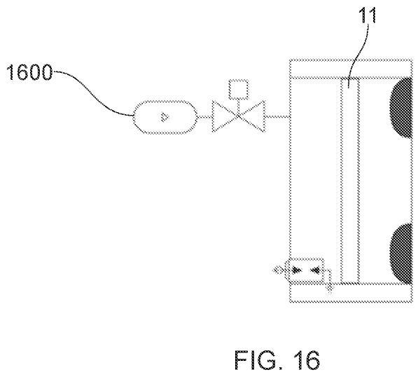

Also, as illustrated in FIGS. 15 and 16, the propulsion mechanism can comprise a pneumatic source 1500 or a source of combustion 1600 in order to propel the actuation mass 11.

Advantageously, as illustrated in FIG. 10, the actuation mechanism 1 comprises a first housing 171 which receives at least partly the actuation mass 11 and the propulsion mechanism 12, and a second housing 172 which receives at least partly the feed head 13, wherein the first and second housings are separable (for example by screwing) and comprise fitting characteristics which cooperate in order to fit the second housing 172 on the first housing 171 in a removable manner.

The first housing 171 is a part which forms an actuator, and the second housing 172 is a part which forms a launcher.

FIG. 11 illustrates an actuator 18 which is configured to be used in an actuation mechanism 1 previously introduced in relation with FIG. 10. In this case, the actuator 18 comprises a housing 181 which receives at least partly an actuation mass 11 and a propulsion mechanism 12 on a first side 111 of the actuation mass 11, wherein the housing 181 comprises an opening 182 in a second side of the actuation mass, in order to allow the actuation mass 11 to cooperate with the feed head 13 of a launcher 19, and a fitting characteristic, in order to allow the actuator to be fitted in a removable manner on the launcher.

Advantageously, the actuator 18 comprises an energy absorber 183 in order to limit the displacement of the actuation mass, as previously discussed in relation with the first and second energy absorbers 151 and 152.

Also, as previously introduced in relation with FIGS. 8 and 9, the actuator 18 can comprise an elastic mechanism fitted on the second side 112 of the actuation mass 11, in order to cooperate in use with a feed head 13 of a launcher on which the actuator is fitted.

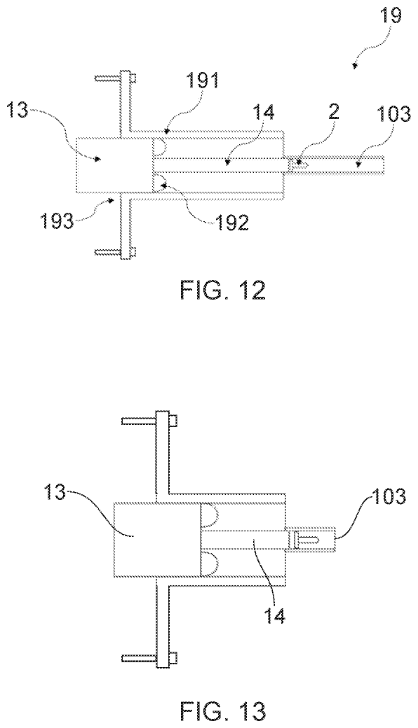

FIG. 12 illustrates the launcher 19 comprising a housing 191 which receives at least partly a feed head 13, and an anvil 14 fitted on the feed head in order to drive a nail 2, wherein the housing comprises an opening 193, in order to allow the feed head to cooperate with an actuation mass 11 of an actuator 18, and a fitting characteristic in the form of bolts, in order to allow the launcher 19 to be fitted in a removable manner on an actuator 18.

FIG. 13 illustrates the launcher 19 of FIG. 12, in the case where the third receptacle has a short length in order to nail nails with short lengths.

Advantageously, the launcher 19 comprises an energy absorber 192, in order to limit the displacement of the feed head, with this energy absorber 192 being able to be integral with the feed head 13, or integral with the housing 191.

Advantageously, the launcher 19 comprises an elastic mechanism fitted on the feed head, on a side facing the opening, in order to cooperate in use with an actuation mass of an actuator on which the launcher is fitted.

Throughout the description and the claims, the words “comprise” and “contain” and their variations signify “including but not limited to”, and they are not intended to (and do not exclude) other parts, additives, or whole or partial components. Throughout the description and the claims of this specification, the singular incorporates the plural, unless the context requires otherwise. In particular, when the indefinite article is used, the specification must be understood as envisaging the plural as well as the singular, unless the context requires something different.

The characteristics, whole numbers, characteristics, components or groups described in association with an aspect, embodiment, or a particular example of the present disclosure, must be understood as being applicable to any other aspect, embodiment or example described in the present disclosure, unless there is incompatibility therewith.

The attention of the reader is drawn to all the papers and documents which have been filed simultaneously with, or prior to this specification in relation with this application, and which are open to public inspection together with this specification, and the content of all these papers and documents is incorporated herein by reference.

1-15. (canceled)

16. An actuation mechanism for a nail driver, the actuation mechanism comprising:
an actuation mass;
a propulsion mechanism on a first side of the actuation mass;
a feed head on a second side of the actuation mass, the feed head separable from the actuation mass; and
an anvil connected to the feed head and engagable with a nail to drive the nail,
wherein, when loaded, the propulsion mechanism is configured to cause the actuation mass to drive the feed head to make the anvil drive the nail into a substrate.

17. The actuation mechanism of claim 16, which includes a first limit stop that limits displacement of the actuation mass to a first distance, and a second limit stop in that limits the displacement of the feed head to a second distance, wherein the second distance is longer than the first distance.

18. The actuation mechanism of claim 16, wherein the feed head is heavier than the actuation mass.

19. The actuation mechanism of claim 16, which includes an elastic mechanism between the feed head and the actuation mass.

20. The actuation mechanism of claim 16, wherein the actuation mass includes an electrically conductive plate, and the propulsion mechanism includes an electrical coil.

21. The actuation mechanism of claim 16, wherein the propulsion mechanism includes a first electrical coil, the actuation mass includes a second electrical coil, and wherein the first and second electrical coils are operable together to propel the second electrical coil, to drive the feed head.

22. The actuation mechanism of claim 16, wherein the propulsion mechanism includes a pneumatic source.

23. The actuation mechanism of claim 16, wherein the propulsion mechanism includes a combustion source.

24. The actuation mechanism of claim 16, which includes a first housing that at least partly houses the actuation mass and the propulsion mechanism, and a second housing that at least partly houses the feed head, wherein the first and second housings are separable.

25. An nail driver comprising:
a housing; and
an actuation mechanism supported by the housing and including:
an actuation mass;
a propulsion mechanism on a first side of the actuation mass;
a feed head on a second side of the actuation mass, the feed head separable from the actuation mass; and
an anvil connected to the feed head and engagable with a nail to drive the nail,
wherein, when loaded, the propulsion mechanism is configured to cause the actuation mass to drive the feed head to make the anvil drive the nail into a substrate.

26. The nail driver of claim 25, which includes a first limit stop that limits displacement of the actuation mass to a first distance, and a second limit stop in that limits the displacement of the feed head to a second distance, wherein the second distance is longer than the first distance.

27. The nail driver of claim 25, wherein the feed head is heavier than the actuation mass.

28. The nail driver of claim 25, which includes an elastic mechanism between the feed head and the actuation mass.

29. The nail driver of claim 25, wherein the actuation mass includes an electrically conductive plate, and the propulsion mechanism includes an electrical coil.

30. The nail driver of claim 25, wherein the propulsion mechanism includes a first electrical coil, the actuation mass includes a second electrical coil, and wherein the first and second electrical coils are operable together to propel the second electrical coil, to drive the feed head.

31. The nail driver of claim 25, wherein the propulsion mechanism includes a pneumatic source.

32. The nail driver of claim 16, wherein the propulsion mechanism includes a combustion source.
